(19) United States
(12) Patent Application Publication
(10) Pub. No.: US 2016/0226283 A1
(43) Pub. Date: Aug. 4, 2016

(54) APPARATUS AND METHOD TO CHANGE CURRENT LIMIT

(71) Applicant: INTEL CORPORATION, Santa Clara, CA (US)

(72) Inventors: Chee Lim NGE, Hillsboro, OR (US); Jorge P. RODRIGUEZ, Portland, OR (US)

(21) Appl. No.: 14/915,019

(22) PCT Filed: Sep. 24, 2014
(86) PCT No.: PCT/US2014/057177

§ 371 Date: Feb. 26, 2016

(30) Foreign Application Priority Data
Sep. 27, 2013 (MY) PI 2013003511

(51) Int. Cl. H02J 7/00; G05F 5/00

(52) U.S. Cl. CPC H02J 7/0052; G05F 5/00; H02J 2007/0062

(57) ABSTRACT

An electronic device and method may change a default current limit of a USB power system. The electronic system may include a cable detector component to detect a plug to couple to a port, a source detector component to determine an identification of a power source, and circuitry to change an input current limit or an output current limit of the electronic device.

### BACKGROUND

1. Field

Embodiments may relate to an electronic device and a power source.

2. Background

An electronic device may utilize a charger (or charging system) in order to provide power. One type of charger is a universal serial bus (USB) charger. There are many different types of USB chargers and different type of protocols. As one example, USB 2.0/3.0 protocol may specify a nominal voltage at 5 volts (V) and a current may be limited to less than 500 milliamps (mA)/900 mA per port. In another example, USB Battery Charging (BC) 1.2 protocol may specify a nominal voltage of 5 V and a maximum allowable current of 1.5 amps (A) per port. However, these power limits may be not sufficient for all electronic devices or platforms.

### BRIEF DESCRIPTION OF THE DRAWINGS

Arrangements and embodiments may be described in detail with reference to the following drawings in which like reference numerals refer to like elements and wherein:

FIG. 1 shows an electronic device according to an example embodiment;

FIG. 2 shows a USB power source according to an example embodiment;

FIG. 3 is a flowchart to show providing a source identifier according to an example embodiment;

FIG. 4 is a flowchart to show detecting a source identifier according to an example embodiment;

FIG. 5 shows a power source and an electronic device (or platform) according to an example embodiment; and

FIG. 6 shows a power source and an electronic device (or platform) according to an example embodiment.

### DETAILED DESCRIPTION

In the following detailed description, like numerals and characters may be used to designate identical, corresponding and/or similar components in differing figure drawings. Further, in the detailed description to follow, example sizes/models/values/ranges may be provided although embodiments are not limited to the same. Where specific details are set forth in order to describe example embodiments, it should be apparent to one skilled in the art that embodiments may be practiced without these specific details.

An electronic device may be any one of a mobile terminal, a mobile device, a mobile computing platform, a mobile platform, a laptop computer, a tablet, an ultra-mobile personal computer, a mobile Internet device, a smartphone, a personal digital assistant, a display device, a television (TV), etc. As one example, an electronic device may be a mobile platform.

The electronic device may include a port to receive an input voltage (or power) and/or to provide an output power. The electronic device may include a charger. The charger may include a voltage regulator (of the electronic device) to provide an output voltage to a load. The voltage regulator may provide a regulated output voltage for the load. As one example, the load may include a display device, a processor, a controller, etc.

The charger may also (or alternatively) provide an output voltage to a battery (provided at the electronic device). The battery may be charged by the voltage received from the charger. The charger may provide an output voltage to the load and/or the battery.

The electronic device may include a port, such as a USB input port, that may receive (or couple to) a power source or a USB device (e.g. a mouse, a keyboard). The electronic device may detect and automatically perform an appropriate action based on the attached device or power source.

The electronic device may utilize Universal Serial Bus (USB) power delivery (PD). A USB charge port of the electronic device may couple to any of a plurality of different devices, including a USB power source.

USB PD may enable functionality of USB by providing flexible power delivery along with data over a single cable (or cable assembly). In USB PD, power directions are no longer fixed. Power distribution may therefore be bi-directional. This may enable an electronic device with power (host or client) to provide power to another device. For example, a display with a power source (i.e., an internal battery or a wall socket) may power or charge a laptop or other electronic device.

The USB charge port may be used to perform various functions such as a laptop computer charging a mobile device (e.g. phone or tablet), a charger (such as a USB charger) charging a laptop computer and/or a USB PD charger to charge a laptop computer. Other types of functions may also be provided.

Devices may be designed and manufactured to comply with a USB PD specification. Components that follow the USB PD specification may include marked cables (or cable assemblies).

According to the USB PD specification, a PD Micro-A connector, a PD Micro-AB connector and a PD Micro-B connector may each separately have a 3 amp current limit According to the USB PD specification, a PD Standard-A connector and a PD Standard-B connector may each separately have a 5 amp current limit. However, in order to overwrite the current limit of USB 2.0/3.0 and BC 1.2, a USB PD system may need an expensive power line communication transceiver and/or a bulky isolation inductor.

A USB PD system may identify a current limit of a USB PD system when a cable is provided at a default voltage, such a 5 volts. The USB PD default current limit may overwrite current limits of USB 2.0/3.0, BC 1.2 and other USB charging systems using non-PD cable assemblies. For example, a USB PD system with PD Micro-A and PD Micro-B connectors may specify a nominal voltage at 5 volts (V) and 3 amp (A) default current limit, which may overwrite USB 2.0 that specifies a nominal voltage at 5 volts (V) and the maximum allowable current at 500 milliamps (mA).

A USB power source and an electronic device may be coupled together by a cable, such as a USB cable. An identification method may be provided that includes a cable detector operation and a source identifier operation.

The cable detector operation may relate to USB PD markings on connectors (or plug connectors) to indicate a current capability of the cable (or cable assemblies). The source identifier operation may include providing a source identifier, such as an electrical signature, on D+ and D− pins of the cable to indicate a current limit of the USB power source.

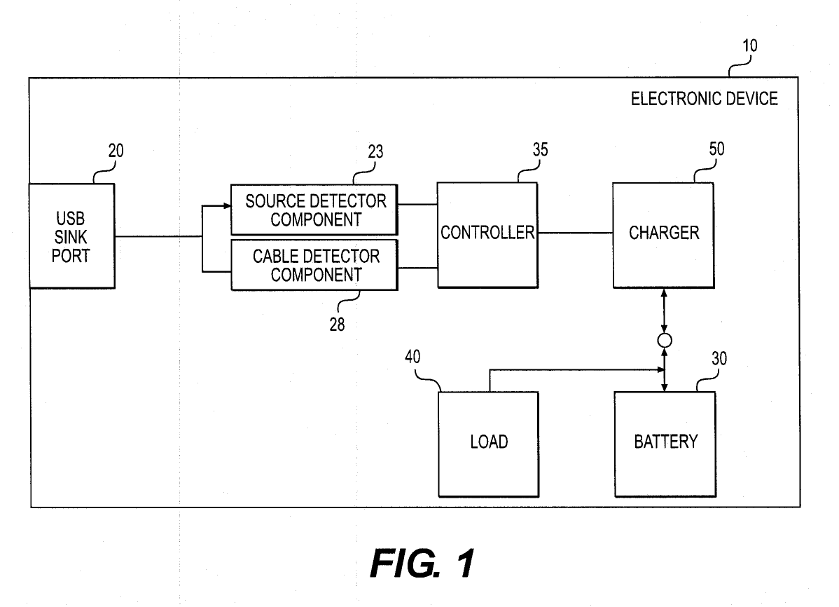

FIG. 1 shows an electronic device according to an example embodiment. Other embodiments and configurations may also be provided.

More specifically, FIG. 1 shows an electronic device 10 having a USB sink port 20 (or a USB charge port), a source detector component 23, a cable detector component 28, a controller 35, a battery charger 50 (or charger), a battery 30 and a load 40. As one example, the USB sink port 20 may have a specific color based on a specific type of the port. With a USB PD charge port, power may flow in either direction (i.e., into the electronic device 10 or out of the electronic device 10).

An external device such as an electronic device and/or a power source may couple to the USB sink port 20 (or the charge port). The power source may be any type of device to provide power.

The sink port 20 may be referred to as a receptacle to receive a connector or a plug of a cable.

The source detector component 23 may receive information from the USB sink port 20, and may provide information to the controller 35. The cable detector component 28 may receive information from the USB sink port 20, and may provide information to the controller 35.

The controller 35 may control operations of the electronic device 10. For example, the controller 35 may control operations of the charger 50, such as based on inputs to the controller 35.

The battery 30 may be a battery pack, a battery cell and/or a plurality of battery cells, for example. The battery 30 may be provided in a battery port of the electronic device 10.

The charger 50 may be referred to as a bi-directional USB buck-boost charger, for example. The charger 50 may provide operations of a buck converter (or voltage step-up converter) and a boost converter (or voltage step-down converter). The charger 50 may be considered bi-directional since the charger 50 may provide power to the electronic device 10 or draw power from the electronic device 10. The charger 50 may operate in a boost configuration or may operate in a buck configuration.

The load 40 may include various components such as a display device, a processor, etc.

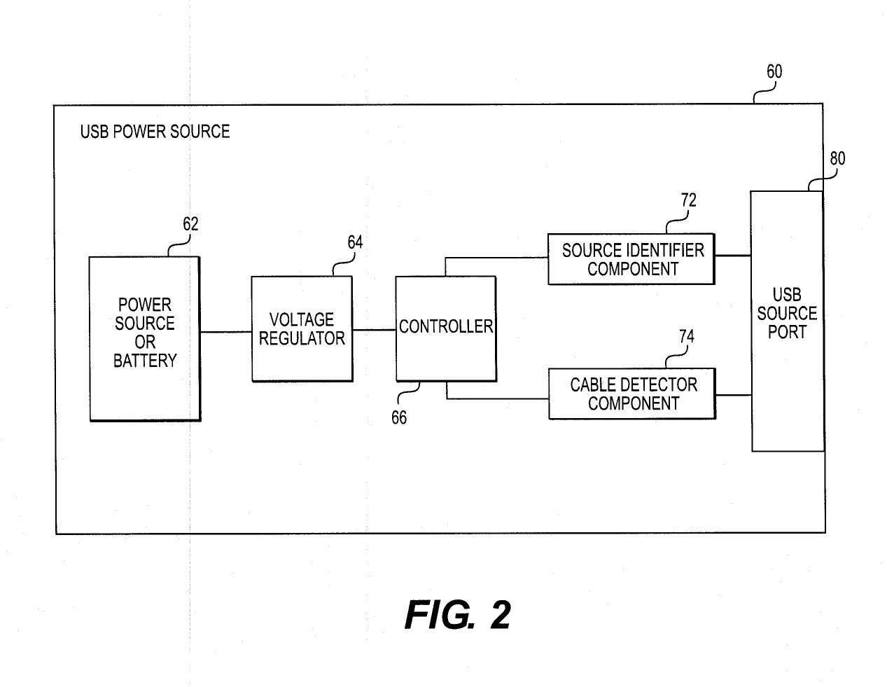

FIG. 2 shows a USB power source according to an example embodiment. Other embodiments and configurations may also be provided.

More specifically, FIG. 2 shows a USB power source 60 that includes a power source or battery 62, a voltage regulator 64, a controller 66, a source identifier component 72, a cable detector component 74 and a USB source port 80.

The cable detector component 74 may receive information from the USB source port 80, and may provide information to the controller 66. The source identifier component 72 may receive information from the controller 66, and may provide information to the USB source port 80.

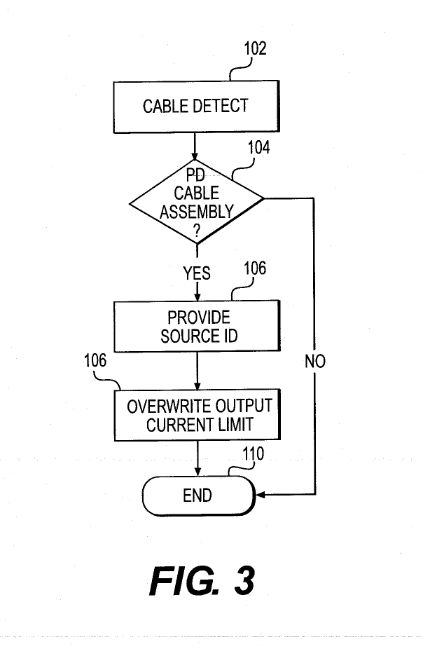

FIG. 3 is a flowchart to show providing a source identifier according to an example embodiment. Other embodiments, operations and orders of operations may also be provided. As one example, a source identifier may be provided from a USB power source to an electronic device (i.e., a host). The electronic device may be a mobile platform, for example.

More specifically, FIG. 3 shows that a cable detection may be provided in operation 102. Operation 104 may include a determination of whether a PD cable (or PD cable assembly) is detected. The determination may be based on an electronic marking of the PD cable. For example, in operation 102 for a USB system with a PD Standard-A receptacle may detect a PD Detect pins (i.e., pins 10 and 11) closed circuit to a shield when the PD plug (of the cable) is inserted into the receptacle. When a non-PD rated USB Standard-A plug is inserted into the receptacle, then operation 102 may detect a PD Detect pins open circuit. The cable detector component (of the USB power source) may measure (or determine) a circuit connection between the PD Detect pins (of the connector/cable) and the shield, and then identify between PD and non-PD rated plugs in operation 104. Operation 104 is a determination to provide a source identifier only when a cable with a PD plug(s) is detected or determined.

The cable detector component may determine that the cable is a power delivery cable based on an electronic marking of the cable. The electronic marking is based on characteristics of the power detect pins of the power delivery cable.

If the determination is that a PD cable (or cable assembly) is detected (i.e., a YES determination), then the USB power source may provide a source identifier in operation 106. The source identifier may be an electrical signature on D+/D− pins of the cable (or connector), for example. The D+/D− pins are part of the cable/connector, which are intended for data transfer. However, since the D+/D− pins are not used for power deliver in USB PD, embodiments may provide that the D+/D− pins may provide a source identification.

The source identifier component may provide a source identifier when the cable is determined to be a power delivery cable. The source identifier may be an electronic signature. The source identifier may be provided over D+/D− pins of the cable.

The source identifier may be provided from the USB power source to the electronic device (such as the charge port). The USB power source may overwrite or change the output current limit in operation 108. As one example, a controller of the USB power source may control a power switch at the USB power source to limit an output current of the power source. The power switch may be a P-channel metal-oxide-silicon field effect transistor (MOSFET), for example, that may be controlled by an output of a comparator (or electronics comparator). Inputs to the comparator may be a measured output current and an output current limit. The comparator may turn off the power switch when the measured output current level exceeds the output current limit.

In at least one embodiment, logic, at least a portion of which is hardware, may change an output current limit of the USB power source, and may provide power at a level less than (or up until) the output current limit. The logic may include the controller, the components and/or circuitry to perform the above described operations.

On the other hand, if operation 104 determines that a PD cable assembly is not detected (i.e., a NO determination), then in operation 110, the cable may be determined to be a non-PD rated cable assembly. This may mean not having a high current capability for the coupled devices (i.e., the electronic device and the USB power source), the USB power source may not provide PD current capability and/or no source identifier may be provided to supply a higher default current.

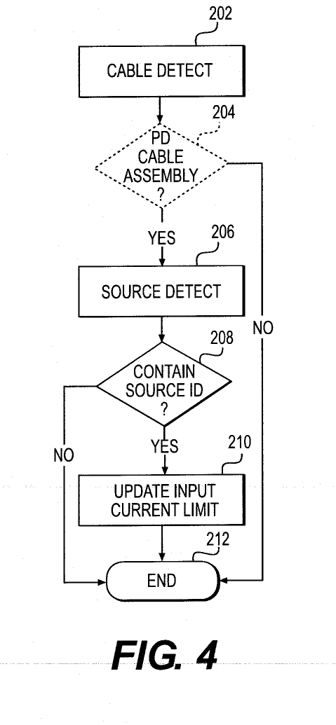

FIG. 4 is a flowchart to show detecting a source identifier according to an example embodiment. Other embodiments, operations and orders of operation may also be provided. As one example, the source identifier may be provided from the USB power source to an electronic device (i.e., a host). The electronic device may therefore detect the source identifier. The electronic device may be a mobile platform, for example.

More specifically, FIG. 4 shows that a cable detection may be provided in operation 202. Operation 204 may include a determination of whether a PD cable (or PD cable assembly) is detected. The determination may be based on an electronic marking of the PD cable. The electronic marking may be an impedance between two pins of the USB connector (of the cable). For example, a PD Micro-B plug capable of 3 amps may have a 10 nanofarads capacitance between an identification (ID) pin and a ground pin. On the other hand, a non-PD Micro-B plug capable of 1.5 amps may have an infinite impedance between the ID pin and the ground pin, and then identify between PD and non-PD rated plugs in operation 204. Operation 204 is the determination to provide a source identifier only when a cable with a PD plug(s) is detected.

If a determination is that a PD cable (or PD cable assembly) is detected (i.e., a YES determination), then the electronic device (or the mobile platform) may detect a source identifier in operation 206. As one example, the source identifier of the PD cable may be electronic markings. The electronic device (i.e., the mobile platform) may detect the source identifier.

In operation 208, a determination may be made whether the source identifier (or the electrical signature) includes a source identification (ID), which may be on the D+/D− pins of the cable, for example. If a determination is that there is the source identification (i.e., Yes in operation 208), then the input current limit of the USB port may be updated (or changed) in operation 210. For a mobile platform device, a battery charge controller may adjust an input current limit of a USB sink port (i.e., the USB charge port). For example, an embedded controller may read a current limit of the USB port from the source identifier component via a serial interface, and the controller may write the current limit to the battery charge controller.

The electronic device may receive power at a limit less than (or up until) the input current limit.

In at least one embodiment, logic at least a portion of which is hardware, may change an input current limit of the electronic device based on the determined identification. The logic may include the controller, the components 23, 28 and/or circuitry to perform the above-described operations.

On the other hand, if operation 204 determines that a PD cable (or cable assembly) is not detected (i.e., a No determination), then in operation 212, the cable may be determined to be a non-PD rated cable. This may mean the cable is not capable of a higher current and the electronic device shall not draw the PD rated current level.

Additionally, if operation 208 determines that a source identification is not contained within the source identifier, then in operation 212, the cable may be determined to be a non-PD rated cable.

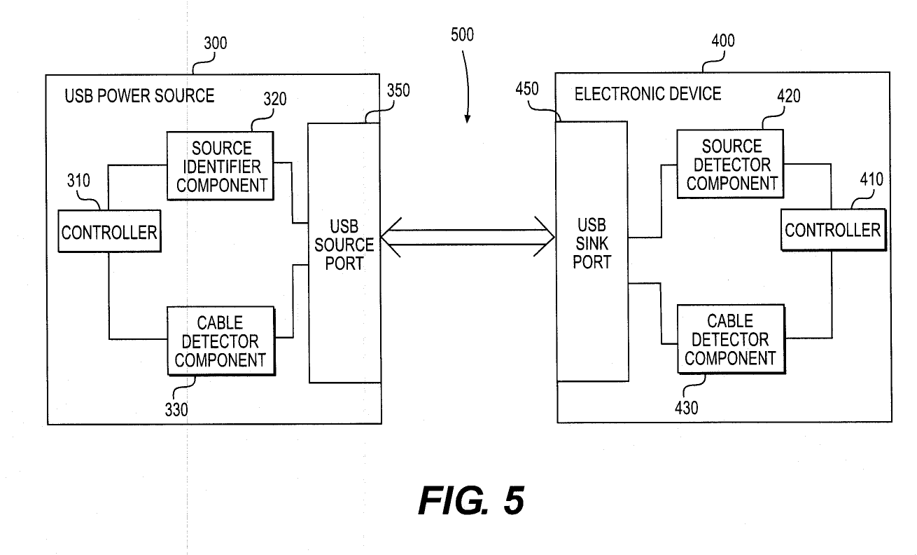

FIG. 5 shows a power source and an electronic device according to an example embodiment. Other embodiments and configurations may also be provided. The electronic device may be a platform, such as a mobile platform.

More specifically, FIG. 5 shows a USB power source 300, a USB source port 350 and a cable 500. The USB source port 350 may be considered as part of the USB power source 300. The USB source port 350 may be a USB Standard-A receptacle, for example. The cable 500 may be a USB PD cable to perform power delivery.

FIG. 5 also shows an electronic device 400, a USB source port 450 and the cable 500. The USB sink port 450 may be considered as part of the electronic device 400. The USB sink port 450 may be a Micro-B receptacle or a Micro-AB receptacle, for example.

As shown in FIG. 5, the USB power source 300 may include a controller 310, a source identifier component 320 and a cable detector component 330. The controller 310 may control the source identifier component 320, and the controller 310 may control the cable detector component 330. The cable detector component 330 may provide information to the controller 310. The source identifier component 320 may provide information to the USB source port 350.

The source identifier component 320 may correspond to the source identifier component discussed above. The cable detector component 330 may correspond to the cable detector component discussed above.

The USB source port 350 may be any one of a number of different types of USB ports, including a Standard-A receptacle and/or a Micro-AB receptacle, for example.

As shown in FIG. 5, the electronic device 400 may include a controller 410, a source detector component 420 and a cable detector component 430. The electronic device 400 may also include a processor, a display, etc.

The source detector component 420 may correspond to the source detector component discussed above. The cable detector component 430 may correspond to the cable detector component discussed above.

The USB sink port 450 may be any one of a number of different types of USB ports, including a Micro-B receptacle and/or a Micro A/B receptacle, for example.

The cable detector component 330 (of the USB power source 300) may detect when a PD rated plug (of the cable 500) is inserted into the USB source port 350 of the power source 300. The cable detector component 330 may then communicate with the controller 310 to indicate that the PD rated plug (of the cable 500) is coupled to the USB source port 350 and the USB power source 300. The controller 310 may then inform the source identifier component 320.

The source identifier component 320 may then provide an electrical signature to the USB source port 350 (and then the cable 500). The electrical signature may be provided thru the cable 500 and to the source detector component 420 of the electronic device 400. The electrical signature may be provided by using a resistor network, for example. The electrical signature may represent the high current capability of the USB power source 300. The controller 310 may read or determine that the cable is PD rated and notify the source identifier component 320 to indicate high current capability to the far end electronic device. The electrical signature may be provided from the resistor network (of the source identifier component 320) and across the D+/D− pins of the cable 500. The electronic signature may be based on the USB power source 300 capability of providing a high current when a PD cable is detected or determined.

The cable detector component 430 (of the electronic device 400) may detect when a PD rated plug (of the cable 500) is inserted to the USB sink port 450 of the electronic device 400. The cable detector component 430 may then communicate with the controller 410 to indicate that the PD rated plug (of the cable 500) is coupled to the electronic device 400. The controller 410 may then inform the source detector component 420.

The source detector component 420 may receive the electronic signature from the USB power source 300. For example, the source detector component 420 may receive the electronic signature from the D+/D− pins of the cable 500. The source detector component 420 may include circuitry that includes voltage and impedance measuring circuits. For example, the source detector component 420 may measure electrical signature across the D+/D− pins, which may be voltage levels or impedances.

Based on the received identification, a controller may control an input current limit of the electronic device 400.

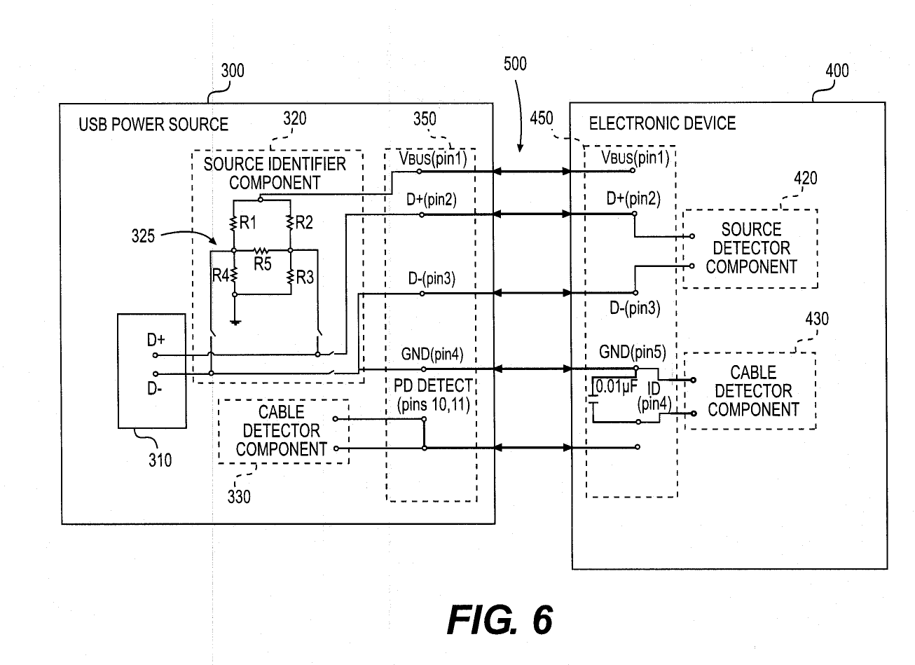

FIG. 6 shows a power source and an electronic device according to an example embodiment. Other embodiments and configurations may also be provided. The electronic device may be a platform, such as mobile platform. The FIG. 6 diagram is intended to show further details of the FIG. 5 configuration.

More specifically, FIG. 6 shows the USB power source 300, the USB source port 350, the electronic device 400 and the USB sink port 450 in more detail. Other configurations may also be provided.

FIG. 6 shows one embodiment of details of the controller 310, the source identifier component 320 and the cable detector component 330.

In FIG. 6, the USB source port 350 may receive a USB PD std-A connector, and the USB sink port 450 may receive a USB PD micro-B connector. A USB PD cable may be provided between the USB source port 350 and the USB sink port 450.

As shown, the controller 310 may provide signals on signal lines corresponding to the D+/D− pins of the cable 500. The D+ pin may be Pin 2, and the D− pin may be Pin 3, for example.

The source identifier component 320 may include a resistor network 325 having a plurality of resistors R1, R2, R3, R4, R5. Other resistors, resistor configurations or circuits may be provided as the source identifier component 320.

The source identifier component 320 may provide an electrical signature on Vbus, which may correspond to Pin 1.

The cable detector component 330 may detect that the cable 500 (and plug) is coupled to the source port 350 of the power source 300. The cable detector component 330 may be coupled to Pins 10 and 11 of the plug, which may serve as PD detect pins.

As shown in FIG. 6, the plug (to couple to the source port 350) may include Vbus on Pin 1, D+ on Pin 2, D− on Pin 3, a Ground on Pin 4 and PD detect on Pins 10, 11. Other configurations may be provided.

The plug (to couple to the sink port 450) may include Vbus on Pin 1, D+ on Pin 2, D− on Pin 3, a Ground (GND) on Pin 5, an ID on Pin 4.

The source detector component 420 may receive D+ inputs from Pin 2 and D− inputs from Pin 3. The source detector component 420 may determine the electric signature based on D+/D− inputs.

The cable detector component 430 may receive inputs from Pin 5 and Pin 4 to detect an electronic marking (or marker). For example, the cable detector component 430 may determine impedance across the pins by measuring a voltage across the pins when an electric current at varying frequency levels is injected through the pins.

As shown in FIG. 6, the electrical signature on the D+/D− pins may be provided using the resistor network (R1, R2, R3, R4, R5). The voltage across D+/D− pins may be less than 3.3V. The source detector component 420 may include voltage and impedance measurement circuitries.

In at least one embodiment, a computer-readable medium may store a program for controlling circuitry of the electronic devices (including the USB power source). The circuitry may be controlled to control components of the USB power source 300 or the electronic device 400. The program may be used by (or rather than) the controller 310 and/or the controller 410 (or processors). The program may be stored in a system memory, which for example, may be internal or external. In at least one embodiment, the program may be part of a control algorithm for controlling operations of the USB power source 300 or the electronic device 400.

Instructions or code executed by the controllers may be provided to a memory from a machine-accessible medium, or an external storage device accessible via a remote connection (e.g. over a network via an antenna and/or network interface) providing access to one or more electronically-accessible media, etc. A machine-accessible medium may include any mechanism that provides (i.e., stores and/or transmits) information in a form readable by a machine (e.g., a computer). For example, a machine-accessible medium may include random access memory (RAM), read only memory (ROM), magnetic or optical storage medium, flash memory devices, electrical, optical, acoustical or other form of propagated signals (e.g., carrier waves, infrared signals, digital signals), etc. In alternative embodiments, hard-wired circuitry may be used in place of or in combination with the instructions or code, and thus the embodiments are not limited to any specific combination of hardware circuitry and software instructions.

The program may include code or instructions to perform any of the operations or functions performed in embodiments previously discussed above.

The following examples pertain to further embodiments.

Example 1 is an electronic device to change an input current limit comprising: a port to receive a plug of a cable, a cable detector component to detect the plug to couple to the port, a source detector component to determine an identification of a power source, and logic, a portion of which is hardware, to change an input current limit of the electronic device based on the determined identification.

In Example 2 the subject matter of Example 1 can optionally include that the cable detector component to determine the cable is a power delivery cable based on an electronic marking of the cable.

In Example 3 the subject matter of Example 2 can optionally include that the electronic marking is based on characteristics of an identification pin and a ground pin of the power delivery cable.

In Example 4 the subject matter of Example 2 can optionally include that the source detector component to determine a source identifier when the cable is determined to be a power delivery cable.

In Example 5 the subject matter of Example 4 can optionally include that the source identifier to be determined based an electronic signature.

In Example 6 the subject matter of Example 4 can optionally include that the source identifier to be provided on D+/D− pins of the cable.

In Example 7 the subject matter of Example 4 can optionally include that the source identifier to be provided over the cable between the power source and the electronic device.

In Example 8 the subject matter of Example 1 can optionally include that the logic includes a controller to change the input current limit of the electronic device.

In Example 9 the subject matter of Example 1 can optionally include that the electronic device to receive power at a current limit less than the input current limit.

In Example 10 the subject matter of Example 1 can optionally include that the port is a universal serial bus (USB) port.

Example 11 is an electronic device to change an output current limit, comprising: a port to receive a plug of a cable, a cable detector component to detect the plug to couple to the port, a source identifier component to provide an identification of the electronic device, and logic, at least a portion of which is hardware, to change an output current limit of the electronic device, and to provide power at a level less than the output current limit.

In Example 12 the subject matter of Example 11 can optionally include that the cable detector component to determine the cable is a power delivery cable based on an electronic marking of the cable.

In Example 13 the subject matter of Example 12 can optionally include that the electronic marking is based on characteristics of power detect pins of the power delivery cable.

In Example 14 the subject matter of Example 12 can optionally include that the source identifier component to provide a source identifier when the cable is determined to be a power delivery cable.

In Example 15 the subject matter of Example 14 can optionally include that the source identifier is an electronic signature.

In Example 16 the subject matter of Example 14 can optionally include that the source identifier to be provided over D+/D− pins of the cable.

In Example 17 the subject matter of Example 14 can optionally include that the source identifier to be provided over the cable between the electronic device and another electronic device.

In Example 18 the subject matter of Example 11 can optionally include that the logic includes a controller to change the output current limit of the electronic device.

In Example 19 the subject matter of Example 11 can optionally include that the electronic device is a power source device.

In Example 20 the subject matter of Example 11 can optionally include that the port is a universal serial bus (USB) port.

Example 21 is an electronic device to change an input current limit, comprising: a port to receive a plug of a cable, means for detecting the plug to couple to the port, means for determine an identification of a power source, and means for changing an input current limit of the electronic device based on the determined identification.

In Example 22 the subject matter of Example 21 can optionally include that the means for determining to determine the cable is a power delivery cable based on an electronic marking of the cable.

In Example 23 the subject matter of Example 22 can optionally include that the means for determining to determine a source identifier when the cable is determined to be a power delivery cable.

In Example 24 the subject matter of Example 22 can optionally include that the source identifier to be determined based an electronic signature.

In Example 25 the subject matter of Example 23 can optionally include that the source identifier to be provided on D+/D− pins of the cable.

In Example 26 the subject matter of Example 23 can optionally include that the source identifier to be provided over the cable between the power source and the electronic device.

In Example 27 the subject matter of Example 21 can optionally include that the means for changing includes a controller to change the input current limit of the electronic device.

In Example 28 the subject matter of Example 21 can optionally include that the electronic device to receive power at a current limit less than the input current limit.

In Example 29 the subject matter of Example 21 can optionally include that the port is a universal serial bus (USB) port.

Example 30 is an electronic device to change an output current limit, comprising: a port to receive a plug of a cable, means for detecting the plug to couple to the port, means for providing an identification of the electronic device, and means for changing an output current limit of the electronic device, and for providing power at a current level up to the output current limit.

In Example 31 the subject matter of Example 30 can optionally include that the means for detecting to determine the cable is a power delivery cable based on an electronic marking of the cable.

In Example 32 the subject matter of Example 31 can optionally include that the means for providing to provide a source identifier when the cable is determined to be a power delivery cable.

In Example 33 the subject matter of Example 32 can optionally include that the source identifier is an electronic signature.

In Example 34 the subject matter of Example 32 can optionally include that the source identifier to be provided over D+/D− pins of the cable.

In Example 35 the subject matter of Example 32 can optionally include that the source identifier to be provided over the cable between the electronic device and another electronic device.

In Example 36 the subject matter of Example 30 can optionally include that the means for changing includes a controller to change the output current limit of the electronic device.

In Example 37 the subject matter of Example 30 can optionally include that the electronic device is a power source device.

In Example 38 the subject matter of Example 30 can optionally include that the port is a universal serial bus (USB) port.

Example 39 is a method of changing an input current limit, comprising: detecting a plug to couple to a port of an electronic device, determining an identification of a power source, and changing an input current limit of the electronic device based on the determined identification.

In Example 40 the subject matter of Example 39 can optionally include that detecting the plug to include determining that a cable is a power delivery cable based on an electronic marking.

In Example 41 the subject matter of Example 40 can optionally include that the electronic marking is based on characteristics of an identification pin and a ground pin of the power delivery cable.

In Example 42 the subject matter of Example 40 can optionally include that determining the identification to include determining a source identifier when the cable is determined to be a power delivery cable.

In Example 43 the subject matter of Example 42 can optionally include that the source identifier to be determined based an electronic signature.

In Example 44 the subject matter of Example 42 can optionally include that the source identifier to be provided on D+/D− pins of the cable.

Example 45 is a method of changing an output current limit, comprising: detecting a plug to couple to a port of an electronic device, providing an identification of the electronic device, changing an output current limit of the electronic device, and providing power at a current limit less than the output current limit.

In Example 46 the subject matter of Example 45 can optionally include that detecting the plug to include determining that a cable is a power delivery cable based on an electronic marking of the cable.

In Example 47 the subject matter of Example 46 can optionally include that the electronic marking is based on characteristics of power detect pins of the power delivery cable.

In Example 48 the subject matter of Example 46 can optionally include that providing the identification to include providing a source identifier when the cable is determined to be a power delivery cable.

In Example 49 the subject matter of Example 48 can optionally include that the source identifier is an electronic signature.

In Example 50 the subject matter of Example 48 can optionally include that the source identifier to be provided over D+/D− pins of the cable.

In Example 51 the subject matter of Example 48 can optionally include that the source identifier to be provided over the cable between the electronic device and another electronic.

Example 52 is a computer-readable medium comprising one or more instructions that when executed on a processor to configure the processor to perform one or more operations to: detect a plug to couple to a port of an electronic device, determine an identification of a power source, and change an input current limit of the electronic device based on the determined identification.

In Example 53 the subject matter of Example 52 can optionally include that to detect the plug to include determining that a cable is a power delivery cable based on an electronic marking.

In Example 54 the subject matter of Example 53 can optionally include that the electronic marking is based on characteristics of an identification pin and a ground pin of the power delivery cable.

In Example 55 the subject matter of Example 53 can optionally include that to determine the identification to include determining a source identifier when the cable is determined to be a power delivery cable.

In Example 56 the subject matter of Example 55 can optionally include that the source identifier to be determined based an electronic signature.

In Example 57 the subject matter of Example 55 can optionally include that the source identifier to be provided on D+/D− pins of the cable.

Example 58 is a computer-readable medium comprising one or more instructions that when executed on a processor to configure the processor to perform one or more operations to: detect a plug to couple to a port of an electronic device, provide an identification of the electronic device, change an output current limit of the electronic device, and provide power at a current limit less than the output current limit.

In Example 59 the subject matter of Example 58 can optionally include that to detect the plug to include determining that a cable is a power delivery cable based on an electronic marking of the cable.

In Example 60 the subject matter of Example 59 can optionally include that the electronic marking is based on characteristics of power detect pins of the power delivery cable.

In Example 61 the subject matter of Example 58 can optionally include that to provide the identification to include providing a source identifier when the cable is determined to be a power delivery cable.

In Example 62 the subject matter of Example 61 can optionally include that the source identifier is an electronic signature.

In Example 63 the subject matter of Example 61 can optionally include that the source identifier to be provided over D+/D− pins of the cable.

In Example 64 the subject matter of Example 61 can optionally include that the source identifier to be provided over the cable between the electronic device and another electronic.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An electronic device to change an input current limit, comprising:
a port to receive a plug of a cable;
a cable detector component to detect the plug to couple to the port;
a source detector component to determine an identification of a power source; and
logic, a portion of which is hardware, to change an input current limit of the electronic device based on the determined identification.

2. The electronic device of claim 1, wherein the cable detector component to determine the cable is a power delivery cable based on an electronic marking of the cable.

3. The electronic device of claim 2, wherein the electronic marking is based on characteristics of an identification pin and a ground pin of the power delivery cable.

4. The electronic device of claim 2, wherein the source detector component to determine a source identifier when the cable is determined to be a power delivery cable.

5. The electronic device of claim 4, wherein the source identifier to be determined based an electronic signature.

6. The electronic device of claim 4, wherein the source identifier to be provided on D+/D− pins of the cable.

7. The electronic device of claim 1, wherein the logic includes a controller to change the input current limit of the electronic device.

8. The electronic device of claim 1, wherein the electronic device to receive power at a current limit less than the input current limit.

9. An electronic device to change an output current limit, comprising:
a port to receive a plug of a cable;
a cable detector component to detect the plug to couple to the port;
a source identifier component to provide an identification of the electronic device; and
logic, at least a portion of which is hardware, to change an output current limit of the electronic device, and to provide power at a level less than the output current limit.

10. The electronic device of claim 9, wherein the cable detector component to determine the cable is a power delivery cable based on an electronic marking of the cable.

11. The electronic device of claim 10, wherein the electronic marking is based on characteristics of power detect pins of the power delivery cable.

12. The electronic device of claim 10, wherein the source identifier component to provide a source identifier when the cable is determined to be a power delivery cable.

13. The electronic device of claim 12, wherein the source identifier is an electronic signature.

14. The electronic device of claim 12, wherein the source identifier to be provided over D+/D− pins of the cable.

15. The electronic device of claim 9, wherein the logic includes a controller to change the output current limit of the electronic device.

16-22. (canceled)

23. A computer-readable medium comprising one or more instructions that when executed on a processor to configure the processor to perform one or more operations to:
detect a plug to couple to a port of an electronic device;
determine an identification of a power source; and
change an input current limit of the electronic device based on the determined identification.

24. A computer-readable medium comprising one or more instructions that when executed on a processor to configure the processor to perform one or more operations to:
detect a plug to couple to a port of an electronic device;
provide an identification of the electronic device;
change an output current limit of the electronic device; and
provide power at a current limit less than the output current limit.

25. The computer-readable medium of claim 24, wherein to detect the plug to include determining that a cable is a power delivery cable based on an electronic marking of the cable.

26. The computer-readable medium of claim 24, wherein to provide the identification to include providing a source identifier when the cable is determined to be a power delivery cable.

27. The computer-readable medium of claim 23, wherein to detect the plug to include determining that a cable is a power delivery cable based on an electronic marking.

28. The computer-readable medium of claim 27, wherein the electronic marking is based on characteristics of an identification pin and a ground pin of the power delivery cable.

29. The computer-readable medium of claim 27, wherein to determine the identification to include determining a source identifier when the cable is determined to be a power delivery cable.

30. The electronic device of claim 4, wherein the source identifier to be provided over the cable between the power source and the electronic device.

31. The electronic device of claim 12, wherein the source identifier to be provided over the cable between the electronic device and another electronic device.

32. The electronic device of claim 9, wherein the electronic device is a power source device.
